(19) United States
(12) Patent Application Publication
(10) Pub. No.: US 2018/0260737 A1
(43) Pub. Date: Sep. 13, 2018

(54) INFORMATION PROCESSING DEVICE, INFORMATION PROCESSING METHOD, AND COMPUTER-READABLE MEDIUM

(71) Applicants: Kabushiki Kaisha Toshiba, Minato-ku (JP); Toshiba Digital Solutions Corporation, Kawasaki-shi (JP)

(72) Inventor: Ryohei TANAKA, Kawasaki (JP)

(73) Assignees: Kabushiki Kaisha Toshiba, Minato-ku (JP); Toshiba Digital Solutions Corporation, Kawasaki-shi (JP)

(21) Appl. No.: 15/709,741

(22) Filed: Sep. 20, 2017

(30) Foreign Application Priority Data
Mar. 9, 2017 (JP) 2017-045089

(51) Int. Cl. G06N 99/00; G06F 17/30; G06N 7/00; G06N 5/04

(52) U.S. Cl. CPC G06N 99/005; G06N 5/047; G06N 7/005; G06F 17/30707

(57) ABSTRACT

According to an embodiment, an information processing device includes a classification unit, a calculation unit, a selection unit, and an allocation unit. The classification unit classifies unlabeled data into groups. The calculation unit calculates an evaluation value of each of the groups depending on label recognition accuracy of a group classifier for recognizing a label for unknown data, the group classifier being generated for each of the groups by using the unlabeled data belonging to the group. The selection unit selects the group based on the evaluation value. The allocation unit allocates a label corresponding to a correct label to the unlabeled data belonging to the selected group.

### CROSS-REFERENCE TO RELATED APPLICATIONS

This application is based upon and claims the benefit of priority from Japanese Patent Application No. 2017-045089, filed on Mar. 9, 2017; the entire contents of which are incorporated herein by reference.

### FIELD

Embodiments described herein relate generally to an information processing device, an information processing method, and a computer-readable medium.

### BACKGROUND

A method for generating a classifier for pattern recognition by performing semi-supervised learning using labeled data and unlabeled data is known. For example, a method in which a classifier learned from labeled data is used to predict a label of unlabeled data and add the label to training data, and learning is repeated to update the classifier is known. A method in which only data whose certainty factor of an estimated label is equal to or higher than a threshold is added to training data rather than adding all pieces of unlabeled data to training data is known.

### BRIEF DESCRIPTION OF THE DRAWINGS

FIG. 1 is a schematic diagram illustrating an example of a configuration of an information processing device;

FIG. 2A is a schematic diagram illustrating an example of data structures of training data and unused data;

FIG. 2B is a schematic diagram illustrating an example of data structures of training data and unused data;

FIG. 3 is a schematic diagram illustrating an example of the flow of information processing;

FIG. 4 is a flowchart illustrating an example of a procedure of the information processing;

FIG. 5 is a schematic diagram illustrating an example of the configuration of an information processing device;

FIG. 6 is a flowchart illustrating an example of a procedure of the information processing;

FIG. 7 is a schematic diagram illustrating an example of a configuration of an information processing device;

FIG. 8 is a flowchart illustrating an example of a procedure of information processing.

FIG. 9 is a schematic diagram illustrating an example of a configuration of an information processing device;

FIG. 10 is a schematic diagram illustrating an example of the flow of information processing;

FIG. 11 is a flowchart illustrating an example of a procedure of the information processing;

FIG. 12 is a schematic diagram illustrating an example of a configuration of an information processing device;

FIG. 13 is a flowchart illustrating an example of a procedure of the information processing; and

FIG. 14 is a hardware configuration diagram of the information processing devices.

### DETAILED DESCRIPTION

In the semi-supervised learning, the accuracy of recognition of classifiers is greatly affected by a threshold used for determination of addition of unlabeled data to training data. In the conventional technology, however, the threshold is not optimized. The conventional technology does not provide training data for generating a classifier having high recognition accuracy.

An information processing device according to an embodiment includes a classification unit, a calculation unit, a selection unit, and an allocation unit. The classification unit classifies unlabeled data into groups. The calculation unit calculates an evaluation value of the group depending on the label recognition accuracy of a group classifier for recognizing a label for unknown data, which is generated for each group by using the unlabeled data belonging to the group. The selection unit selects the group based on the evaluation value. The allocation unit allocates a label corresponding to a correct label to the unlabeled data belonging to the selected group.

Referring to the accompanying drawings, an information processing device, an information processing method, and an information processing program according to embodiments are described in detail below.

### First Embodiment

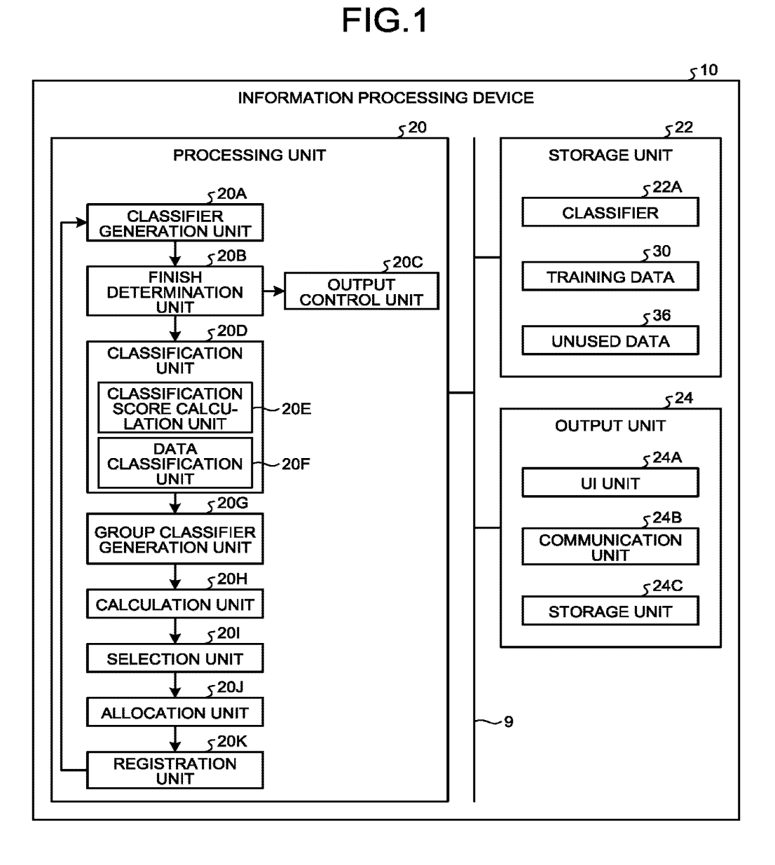

FIG. 1 is a schematic diagram illustrating an example of a configuration of an information processing device 10 according to a first embodiment.

The information processing device 10 in the first embodiment creates a classifier by using training data (details are described later). The information processing device 10 in the first embodiment performs semi-supervised learning to allocate a label to unlabeled data and add the unlabeled data to training data (details are described later).

The information processing device 10 includes a processing unit 20, a storage unit 22, and an output unit 24. The processing unit 20, the storage unit 22, and the output unit 24 are connected via a bus 9.

The storage unit 22 stores various kinds of data therein. Examples of the storage unit 22 include a hard disk drive (HDD), an optical disc, a memory card, and a random-access memory (RAM). The storage unit 22 may be provided in an external device connected via a network.

In the first embodiment, the storage unit 22 stores therein a classifier 22A, training data 30, and unused data 36. The storage unit 22 also stores therein various kinds of data generated during processing by the processing unit 20.

The classifier 22A is a classifier for recognizing (or specifying) a correct label for unknown data. The classifier 22A is created and updated by the processing unit 20 described later.

The training data 30 registers labeled data. For example, the training data 30 is a database. The data structure of the training data 30 is not limited to a database.

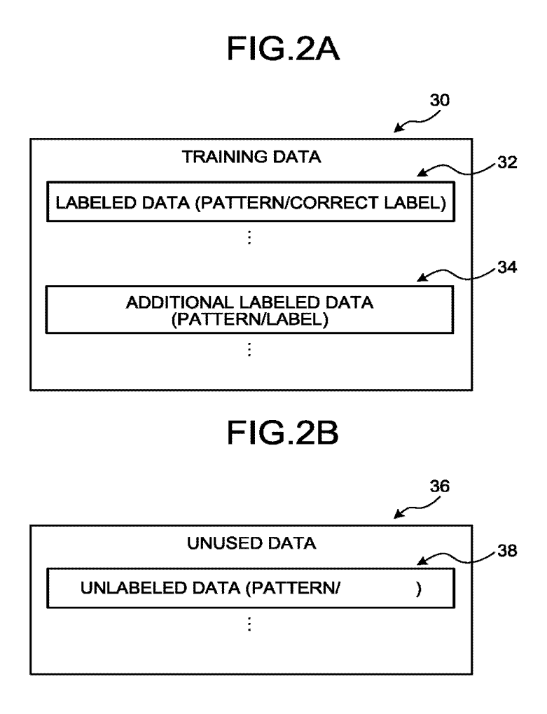

FIG. 2A is a schematic diagram illustrating an example of the data structure of the training data 30. The training data 30 includes labeled data 32 and additional labeled data 34.

The labeled data 32 is data allocated with a correct label. Specifically, the labeled data 32 includes a pattern and a correct label corresponding to the pattern. The labeled data 32 is data provided by an external device in advance.

The additional labeled data 34 is data allocated with a label by the processing unit 20 described later. Specifically, the additional labeled data 34 includes a pattern and a label corresponding to the pattern.

In the initial state, only the labeled data 32 is stored in the training data 30. Through processing by the processing unit 20 described later, the additional labeled data 34 is added to the training data 30 (details are described later).

FIG. 2B is a schematic diagram illustrating an example of the data structure of the unused data 36. The unused data 36 registers unlabeled data 38 therein. For example, the unused data 36 is a database. The data structure of the unused data 36 is not limited to a database.

The unlabeled data 38 is registered in the unused data 36. The unlabeled data 38 is data to be processed by the information processing device 10, and is unlabeled data. Specifically, the unlabeled data 38 includes a pattern, and a label corresponding to the pattern has not been allocated yet.

In the first embodiment, the additional labeled data 34 to be processed is registered in the training data 30 through the processing by the processing unit 20 described later.

Referring back to FIG. 1 to continue the description, the output unit 24 outputs various kinds of data. For example, the output unit 24 includes an UI unit 24A, a communication unit 24B, and a storage unit 24C.

The UI unit 24A has a display function for displaying various kinds of images and an input function for receiving an operation instruction from a user. For example, the display function is a display such as an LCD. For example, the input function is a mouse or a keyboard. The UI unit 24A may be a touch panel that has the display function and the input function integrally. The UI unit 24A may be configured such that a display unit having the display function and an input unit having the input function are provided separately.

The communication unit 24B communicates with an external device via a network or the like. The storage unit 24C stores various kinds of data therein. The storage unit 24C may be integrated with the storage unit 22. In the first embodiment, the classifier 22A defined by the processing unit 20 is stored in the storage unit 24C.

The processing unit 20 includes a classifier generation unit 20A, a finish determination unit 20B, an output control unit 20C, a classification unit 20D, a group classifier generation unit 20G, a calculation unit 20H, a selection unit 20I, an allocation unit 20J, and a registration unit 20K. The classification unit 20D includes a classification score calculation unit 20E and a data classification unit 20F.

Each of the above-mentioned units is implemented by, for example, one or more processors. For example, each of the above-mentioned units may be implemented by a processor such as a central processing unit (CPU) executing a computer program, that is, by software. Each of the above-mentioned units may be implemented by a processor such as a dedicated integrated circuit (IC), that is, by hardware. Each of the above-mentioned units may be implemented by software and hardware in combination. In the case of using processors, each of the processors may implement one of the units or implement two or more of the units.

The classifier generation unit 20A generates the classifier 22A by using the training data 30. The classifier 22A is a classifier for recognizing a correct label for unknown data. Specifically, the classifier generation unit 20A generates the classifier 22A for estimating a correct label indicating a category to which unknown data belongs. The classifier 22A can be generated by a publicly known method.

The training data 30 is updated by processing described later. The classifier generation unit 20A generates a classifier 22A by using the updated training data 30.

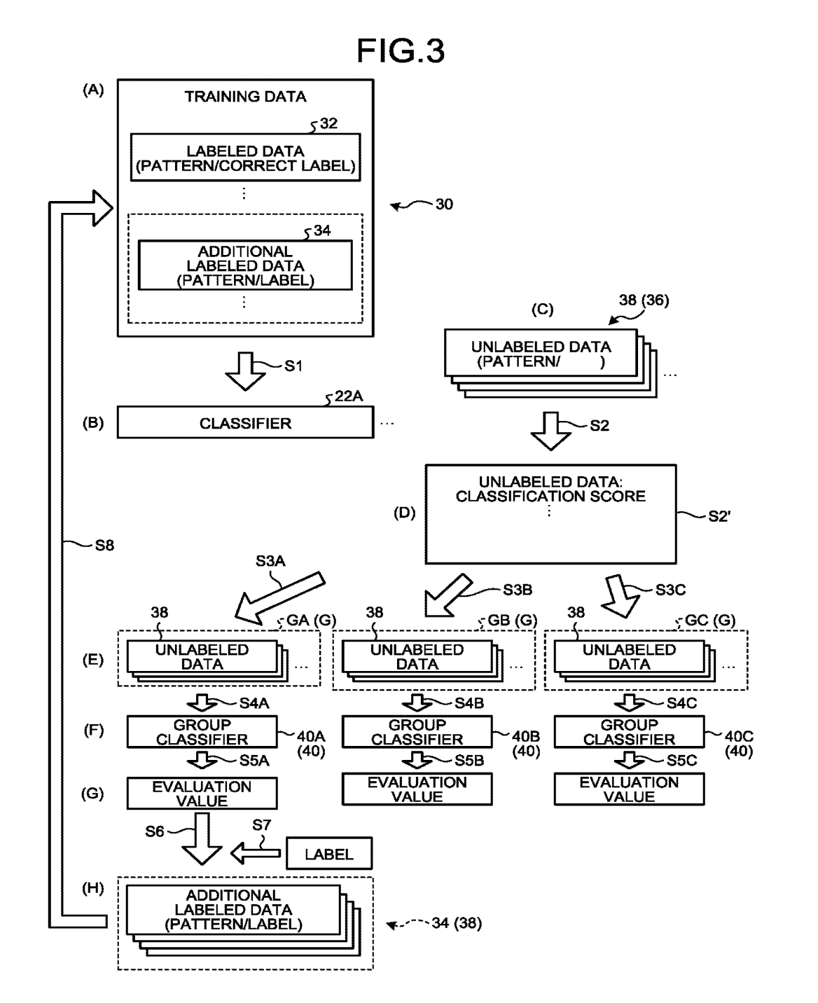

FIG. 3 is a schematic diagram illustrating the flow of information processing executed by the processing unit 20. As illustrated at part (A) and part (B) in FIG. 3, the classifier generation unit 20A uses training data 30 to generate a classifier 22A (Step S1). In the initial state, only labeled data 32 is registered in the training data 30. Additional labeled data 34 is added to the training data 30 through processing described later. The classifier generation unit 20A uses the latest training data 30 to generate the classifier 22A.

The description is continued with reference back to FIG. 1. The finish determination unit 20B determines whether to finish the learning. The finish determination unit 20B determines whether to finish a series of processing (that is, learning) involving the update of the training data 30 and the generation of the classifier 22A.

For example, the finish determination unit 20B determines whether to finish the learning by determining whether a finish condition is satisfied. The finish condition can be set in advance. For the finish condition, the condition that the learning cannot be continued or the condition that the improvement rate of recognition accuracy of the classifier 22A remains equal to or lower than a threshold even after the learning is continued can be set in advance. Examples of the finish condition include the case where no unlabeled data 38 exists in the unused data 36 and the case where the training data 30 remains unchanged for a predetermined number of times. The predetermined number of times indicates a predetermined number of times of registration processing by the registration unit 20K described later.

The output control unit 20C controls the output unit 24 to output various kinds of data. In the first embodiment, the output control unit 20C outputs the latest classifier 22A obtained when it is determined by the finish determination unit 20B to finish the learning as the finally defined classifier 22A. Specifically, the output control unit 20C executes at least one processing of transmitting the defined classifier 22A to an external device through the communication unit 24B, storing the defined classifier 22A in the storage unit 24C, or displaying the defined classifier 22A on the UI unit 24A.

The classification unit 20D classifies unlabeled data 38 registered in unused data 36 into groups. In the first embodiment, pieces of unlabeled data 38 are registered in the unused data 36. The classification unit 20D classifies the pieces of unlabeled data 38 into groups.

In the first embodiment, the classification unit 20D classifies the unlabeled data 38 into groups depending on correct labels. Specifically, the classification unit 20D classifies the pieces of unlabeled data 38 into groups depending on correct labels.

In the first embodiment, the classification unit 20D includes the classification score calculation unit 20E and the data classification unit 20F.

The classification score calculation unit 20E calculates a classification score for the unlabeled data 38. The classification score is a value related to the similarity to a correct label registered in the training data 30.

For example, as illustrated at part (C) and part (D) in FIG. 3, the classification score calculation unit 20E calculates a classification score for each of the pieces of unlabeled data 38 (Step S2, Step S2′).

In some cases, correct labels are registered in the training data 30. Accordingly, the classification score calculation unit 20E calculates, for each piece of unlabeled data 38 registered in the unused data 36, the degree of similarity to each of the correct labels registered in the training data 30. The classification score calculation unit 20E uses, for each piece of the unlabeled data 38, the highest degree of similarity among the degrees of similarity to the correct labels as a classification score of the unlabeled data 38. The classification score calculation unit 20E may use, for each piece of the unlabeled data 38, a difference between the highest degree of similarity and the next highest degree of similarity among the degrees of similarity to the correct labels as the classification score.

In this manner, the classification score calculation unit 20E calculates one classification score for each piece of unlabeled data 38.

The description is continued with reference back to FIG. 1. The data classification unit 20F classifies the unlabeled data 38 into groups depending on the classification score. For example, the data classification unit 20F classifies the pieces of unlabeled data 38 into groups such that a group of unlabeled data 38 whose classification scores are similar belong to the same group.

For example, as illustrated at part (D) and part (E) in FIG. 3, the data classification unit 20F classifies the pieces of unlabeled data 38 into groups G (groups GA, GB, and GC in the example illustrated in FIG. 3) depending on classification scores (Steps S3A, S3B, and S3C).

Specifically, the classification score is a value ranging from “0.0” to “1”. In this case, for example, the data classification unit 20F classifies the pieces of unlabeled data 38 into three groups in which the smaller than “0.3”, the classification score is in the range of “0.3” or larger to smaller than “0.6”, and the classification score is in the range of “0.6” or larger to “1.0” or smaller.

The number of classified groups is not limited as long as being plural. The range of the classification score used for the classification can be freely set, and is not limited to the above-mentioned range.

The description is continued with reference back to FIG. 1. The group classifier generation unit 20G uses the unlabeled data 38 belonging to each of the groups G classified by the classification unit 20D to generate a group classifier for each group G. The group classifier is a classifier for recognizing a label for unknown data.

The group classifier generation unit 20G can generate a group classifier by using unlabeled data 38 belonging to a group G and training data 30. A label recognized with use of the classifier 22A can be used as a label to be allocated to the unlabeled data 38.

The group classifier generation unit 20G may generate a group classifier by using the same method as that for the classifier generation unit 20A.

The group classifier generation unit 20G may generate a group classifier by using a method different from that for the classifier generation unit 20A. For example, the group classifier generation unit 20G may generate a group classifier by using a simple method with a smaller amount of calculation than that of the classifier generation unit 20A. In this case, the amount of calculation by the processing unit 20 as a whole can be reduced.

For example, as illustrated at part(E) and part(F) in FIG. 3, the group classifier generation unit 20G generates group classifiers 40 (group classifiers 40A, 40B, and 40C) corresponding to the groups G (groups GA, GB, and GC), respectively (Steps S4A, S4B, and S4C).

The description is continued with reference back to FIG. 1. The calculation unit 20H uses the group classifier 40 to calculate an evaluation value of a group G corresponding to the group classifier 40 (see Steps S5A, S5B, and S5C in part (G) of FIG. 3). For example, the calculation unit 20H calculates the evaluation value depending on the recognition accuracy of labels to the group classifier 40.

Specifically, the calculation unit 20H uses the group classifier 40 to recognize labels in a predetermined pattern group. The predetermined pattern group is a group of patterns of at least part of labeled data 32 registered in the training data 30. The calculation unit 20H calculates, as an evaluation value, at least one of the ratio of labels recognized with use of the group classifier 40 to correct labels, the misrecognition rate, the rejection rate, or the output value of a function whose input variable is the data count.

The rejection rate indicates the ratio of rejected patterns to recognized patterns. The rejection is processing for suspending the calculation of recognition results due to low certainty factor of recognition. Specifically, a pattern whose classification score satisfies predetermined criteria, such as being equal to or being lower than a given value, is to be rejected. The function whose input variable is the data count is a function indicating the scale of a subject group. The data count indicates the number of unlabeled data 38 belonging to the subject group.

The selection unit 20I selects a group G on the basis of the evaluation value. For example, the selection unit 20I selects a group G whose evaluation value is equal to or larger than a threshold from among the groups G classified by the classification unit 20D.

The selection unit 20I only needs to select a group G whose evaluation value is equal to or larger than a threshold, and the number of groups G selected is not limited. The threshold of the evaluation value may be set in advance. For example, a value that obtains a target evaluation value may be set for the threshold of the evaluation value. The threshold of the evaluation value may be changed as appropriate in response to an operation instruction from a user.

For another example, the selection unit 20I may select a predetermined number of groups G in descending order of evaluation values from among the groups G classified by the classification unit 20D. The predetermined number can be set in advance. The predetermined number may be changed as appropriate in response to an operation instruction from a user.

For example, the selection unit 20I selects a group GA from among the groups G (groups GA, GB, and GC) depending on evaluation values (see part (G) in FIG. 3, Step S6).

The allocation unit 20J allocates a label corresponding to a correct label to unlabeled data 38 belonging to the group G selected by the selection unit 20I (see part (G) in FIG. 3, Step S7).

Specifically, the allocation unit 20J specifies, for each of the unlabeled data 38 belonging to the group G, a correct label having the highest degree of similarity used to derive the classification score calculated by the classification score calculation unit 20E. The allocation unit 20J allocates the specified correct label as a label corresponding to the pattern included in the unlabeled data 38.

The registration unit 20K registers the labeled unlabeled data 38 to the training data 30 as additional labeled data 34. Thus, as illustrated at part (H) in FIG. 3, part (A) in FIG. 3, and Step S8, the additional labeled data 34 is added to the training data 30 (see FIG. 2A as well).

In this case, the registration unit 20K deletes the labeled unlabeled data 38 from the unused data 36, and then registers the labeled unlabeled data 38 to the training data 30 as the additional labeled data 34. Thus, only unlabeled data 38 is registered in the unused data 36 (see FIG. 2B).

Because the additional labeled data 34 is added to the training data 30, each time the training data 30 is updated, the classifier generation unit 20A generates a classifier 22A by using the updated training data 30 (see part (A) in FIG. 3, part (B) in FIG. 3, Step S1).

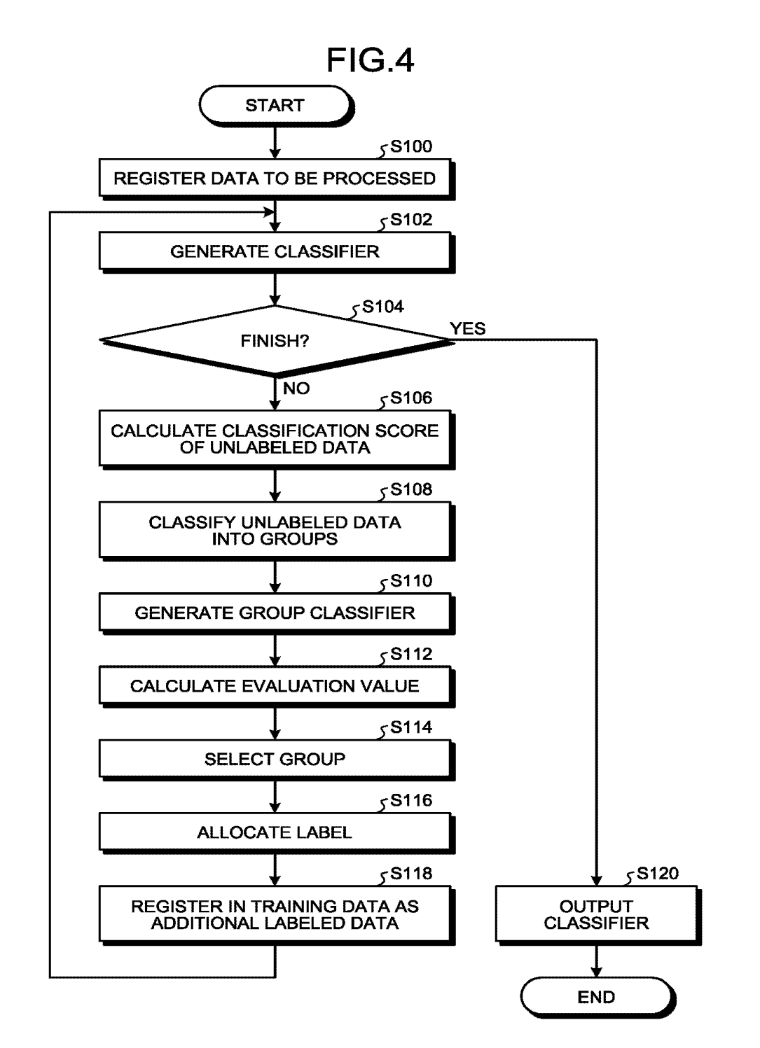

Next, a procedure of the information processing executed by the information processing device 10 in the first embodiment is described. FIG. 4 is a flowchart illustrating an example of the procedure of the information processing executed by the information processing device 10 in the first embodiment.

The description is given on the assumption that in the state before the information processing in FIG. 4 is executed, no data has existed in the training data 30 and the unused data 36. First, the processing unit 20 registers data to be processed in training data 30 and unused data 36 (Step S100). For example, it is assumed that the processing unit 20 receives pieces of labeled data 32 and pieces of unlabeled data 38 from an external device as data to be processed. The processing unit 20 registers the pieces of labeled data 32 in the training data 30, and registers the pieces of unlabeled data 38 in the unused data 36.

Next, the classifier generation unit 20A generates a classifier 22A by using the training data 30 (Step S102).

Next, the finish determination unit 20B determines whether to finish learning (Step S104). When it is determined not to finish learning (No at Step S104), the flow proceeds to Step S106.

At Step S106, the classification score calculation unit 20E in the classification unit 20D calculates a classification score for each of the unlabeled data 38 registered in the unused data 36 (Step S106).

Next, the data classification unit 20F classifies the pieces of unlabeled data 38 registered in the unused data 36 into groups G depending on classification scores (Step S108). The group classifier generation unit 20G generates a group classifier 40 corresponding to each of the groups G classified at Step S108 (Step S110). Next, the calculation unit 20H uses the group classifier 40 to calculate an evaluation value of the group G corresponding to the group classifier 40 (Step S112).

Next, the selection unit 20I selects a group on the basis of the evaluation value calculated at Step S112 (Step S114). As described above, for example, the selection unit 20I selects a group G whose evaluation value is equal to or larger than a threshold from among the groups G classified by the classification unit 20D.

Next, the allocation unit 20J allocates a label corresponding to a correct label to the unlabeled data 38 belonging to the group G selected at Step S114 (Step S116).

Next, the registration unit 20K registers the unlabeled data 38 labeled at Step S116 to the training data 30 as additional labeled data 34 (Step S118). In this case, the registration unit 20K deletes the labeled unlabeled data 38 from the unused data 36. The flow returns to Step S102.

When it is determined to be positive at Step S104 (Yes at Step S104), on the other hand, the flow proceeds to Step S120.

At Step S120, the output control unit 20C outputs the latest classifier 22A generated by the previous processing of Step S102 as the finally defined classifier 22A (Step S120). This routine is finished.

As described above, the information processing device 10 in the first embodiment includes the classification unit 20D, the calculation unit 20H, the selection unit 20I, and the allocation unit 20J. The classification unit 20D classifies unlabeled data 38 into groups G. The calculation unit 20H calculates an evaluation value of the group G depending on the recognition accuracy of labels to a group classifier 40 for recognizing a label for unknown data, which is generated for each group G by using unlabeled data 38 belonging to the group G. The selection unit 20I selects the group G on the basis of the evaluation value. The allocation unit 20J allocates a label corresponding to a correct label to the unlabeled data 38 belonging to the selected group G.

In this manner, the information processing device 10 in the first embodiment allocates a label to unlabeled data 38 that belongs to a group G selected depending on the evaluation value of the label recognition accuracy of a corresponding group classifier 40 among the unlabeled data 38. Thus, the information processing device 10 in the first embodiment can selectively label unlabeled data 38 that may contribute to improving recognition accuracy among pieces of unlabeled data 38.

Consequently, the information processing device 10 in the first embodiment can provide data (training data 30) for generating a classifier 22A having high recognition accuracy.

### Second Embodiment

In a second embodiment, an embodiment in which groups are reclassified and additional labeled data 34 in training data 30 is corrected is described.

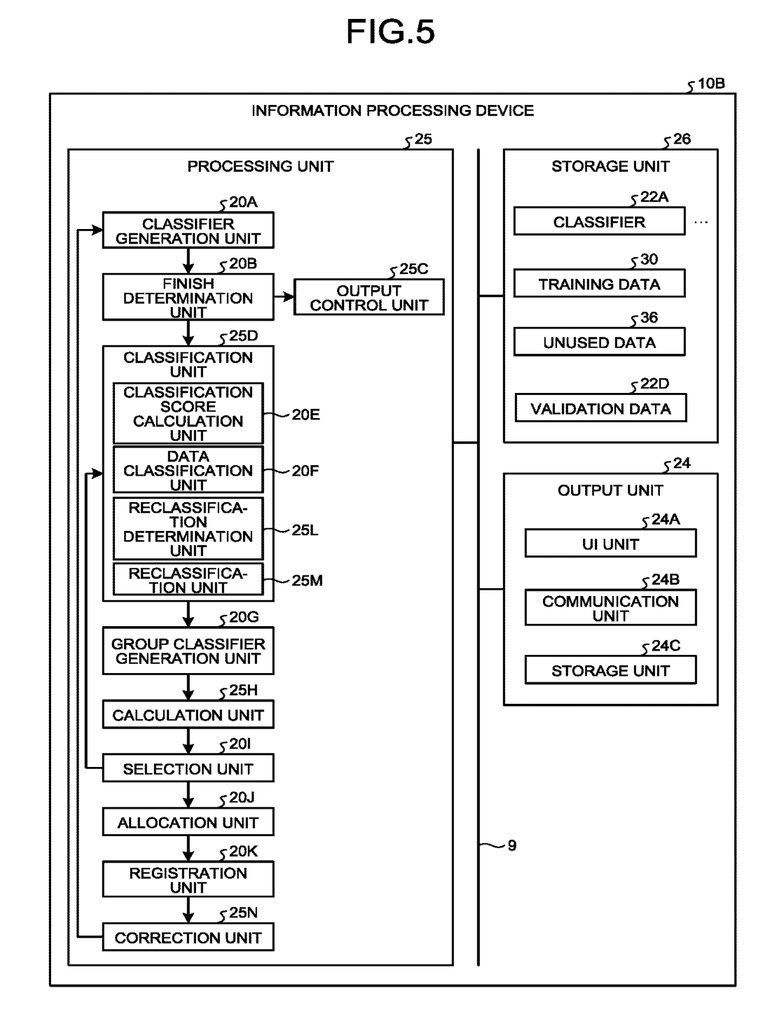

FIG. 5 is a schematic diagram illustrating an example of a configuration of an information processing device 10B in the second embodiment. Configurations having the same functions as those in the first embodiment are denoted by the same reference symbols, and descriptions thereof are sometimes omitted.

The information processing device 10B includes a processing unit 25, a storage unit 26, and an output unit 24. The processing unit 25, the storage unit 26, and the output unit 24 are connected via a bus 9. The output unit 24 is the same as in the first embodiment.

The storage unit 26 stores various kinds of data therein. The storage unit 26 stores therein a classifier 22A, training data 30, unused data 36, and validation data 22D. In the second embodiment, the storage unit 26 stores classifiers 22A therein. Similarly to the first embodiment, the processing unit 25 in the information processing device 10B repeatedly executes the update of the training data 30 and the generation of the classifiers 22A. In the second embodiment, each time a new classifier 22A is generated, the storage unit 26 adds version information and stores each of the generated classifiers 22A therein. Thus, the same number of classifiers 22A as the number by which the classifiers 22A are generated by the processing unit 25 are stored in the storage unit 26.

The validation data 22D registers data allocated with a correct label. For example, the validation data 22D is a database. The data structure of the validation data 22D is not limited to a database.

The validation data 22D is data that is not used for learning but is used only for calculation of the evaluation value. A correct label of the validation data 22D and a correct label of the labeled data 32 are labels of the same type. On the other hand, a pattern of the validation data 22D and a pattern of the labeled data 32 may be the same or different.

The processing unit 25 includes a classifier generation unit 20A, a finish determination unit 20B, an output control unit 25C, a classification unit 25D, a group classifier generation unit 20G, a calculation unit 25H, a selection unit 20I, an allocation unit 20J, a registration unit 20K, and a correction unit 25N. The classification unit 25D includes a classification score calculation unit 20E, a data classification unit 20F, a reclassification determination unit 25L, and a reclassification unit 25M.

Each of the above-mentioned units is implemented by, for example, one or more processors. For example, each of the above-mentioned units may be implemented by a processor such as a CPU executing a computer program, that is, by software. Each of the above-mentioned units may be implemented by a processor such as a dedicated IC, that is, by hardware. Each of the above-mentioned units may be implemented by software and hardware in combination. In the case of using processors, each of the processors may implement one of the units or implement two or more of the units.

The classifier generation unit 20A, the finish determination unit 20B, the classification score calculation unit 20E, the data classification unit 20F, the group classifier generation unit 20G, the selection unit 20I, the allocation unit 20J, and the registration unit 20K are the same as in the first embodiment.

In the second embodiment, the classification unit 25D includes a classification score calculation unit 20E, a data classification unit 20F, a reclassification determination unit 25L, and a reclassification unit 25M.

The reclassification determination unit 25L determines whether to reclassify the group G selected by the selection unit 20I. Specifically, the reclassification determination unit 25L determines whether the group G selected by the selection unit 20I is a group G satisfying the reclassification conditions. Examples of the reclassification conditions include the condition that the number of unlabeled data 38 belonging to a group G is equal to or larger than a predetermined number.

When the reclassification determination unit 25L determines to reclassify the group G, the reclassification unit 25M reclassifies the group G selected by the selection unit 20I. The reclassification unit 25M can reclassify the group G similarly to the data classification unit 20F. For example, the reclassification unit 25M reclassifies the group G into groups G. Specifically, the reclassification unit 25M reclassifies a group G that is immediately selected by the selection unit 20I among the previously classified groups G into finer groups G.

In this case, the reclassification unit 25M can reclassify the group G selected by the selection unit 20I such that the group G is classified into groups G that are finer than the previously classified groups. For example, the reclassification unit 25M reclassifies the group G in a manner that the range of classification scores for the same group G used in the previous classification of groups G is set to be narrower than the previous range.

The calculation unit 25H uses the group classifier 40 to calculate an evaluation value of a group G corresponding to the group classifier 40 similarly to the calculation unit 20H in the first embodiment. The calculation unit 25H uses a group of patterns in at least part of labeled data 32 registered in the validation data 22D.

Specifically, the calculation unit 25H recognizes labels in a predetermined pattern group by using a group classifier 40. The predetermined pattern group is a group of patterns of at least part of labeled data 32 registered in the validation data 22D. Similarly to the calculation unit 20H, the calculation unit 25H calculates at least one of the ratio of labels recognized with use of the group classifier 40 to correct labels, the misrecognition rate, the rejection rate, or the output value of a function whose input variable is the data count as an evaluation value.

The correction unit 25N corrects additional labeled data 34 satisfying the first condition among the additional labeled data 34 in the training data 30. The first condition indicates that the classification score is equal to or smaller than a predetermined score.

In this case, the registration unit 20K may register, at the time of registering the additional labeled data 34 in the training data 30, a classification score calculated by the classification score calculation unit 20E obtained at the time of classification into the groups G, in the additional labeled data 34 in association with each other.

The correction unit 25N may specify additional labeled data 34 whose corresponding classification score is equal to or smaller than a predetermined score among the additional labeled data 34 registered in the training data 30 as the additional labeled data 34 satisfying the first condition.

The correction unit 25N corrects the additional labeled data 34 satisfying the first condition by at least one of changing the allocated label, removing the allocated label and moving the additional labeled data 34 to the unused data 36, or deleting the additional labeled data 34 from the training data 30.

In the case of changing a label, the correction unit 25N recognizes a correct label corresponding to a pattern of the additional labeled data 34 satisfying the first condition by using the latest classifier 22A. The correction unit 25N changes the label allocated to the additional labeled data 34 to the recognized correct label.

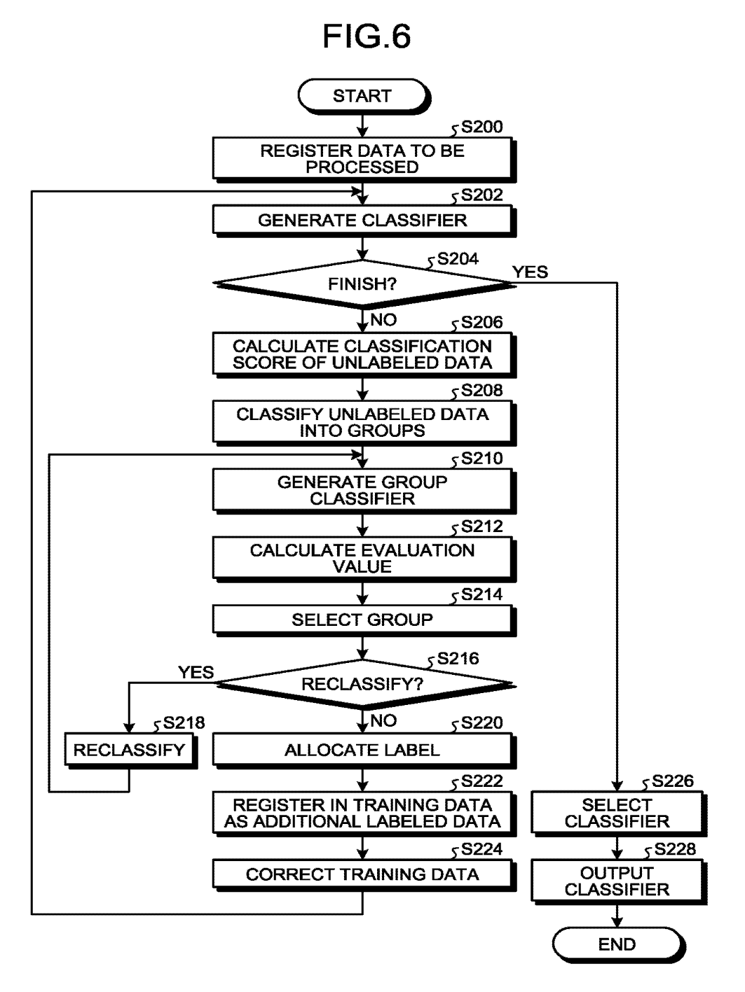

Next, a procedure of the information processing executed by the information processing device 10B in the second embodiment is described. FIG. 6 is a flowchart illustrating an example of the procedure of the information processing executed by the information processing device 10B in the second embodiment.

First, the processing unit 25 registers data to be processed in the storage unit 26 (Step S200). In the second embodiment, the processing unit 25 receives data to be processed including pieces of labeled data 32, pieces of unlabeled data 38, and validation data 22D from an external device. The processing unit 25 registers the pieces of labeled data 32 in the training data 30, and registers the pieces of unlabeled data 38 in the unused data 36. The processing unit 25 registers the validation data 22D in the storage unit 26.

Next, the classifier generation unit 20A uses the training data 30 to generate the classifier 22A (Step S202). In the second embodiment, each time the classifier generation unit 20A generates a new classifier 22A, the classifier generation unit 20A stores the generated classifier 22A and version information of the classifier 22A in the classifier 22A in association with each other.

Next, the processing unit 25 executes the processing of Step S204 to Step S210 similarly to the first embodiment (see Step S104 to Step S110 in FIG. 4).

Specifically, the finish determination unit 20B determines whether to finish the learning (Step S204). When it is determined not to finish the learning (No at Step S204), the flow proceeds to Step S206. At Step S206, the classification score calculation unit 20E in the classification unit 25D calculates a classification score for each of the unlabeled data 38 registered in the unused data 36 (Step S206). Next, the data classification unit 20F classifies the pieces of unlabeled data 38 registered in the unused data 36 into groups G depending on classification scores (Step S208). Next, the group classifier generation unit 20G generates group classifiers 40 corresponding to the groups G classified at Step S208 (Step S210).

Next, the calculation unit 25H uses the group classifier 40 and the validation data 22D to calculate an evaluation value of the group G corresponding to the group classifier 40 (Step S212).

Next, the selection unit 20I selects a group G on the basis of the evaluation value calculated at Step S212 (Step S214).

Next, the reclassification determination unit 25L determines whether to reclassify the group G selected at Step S214 (Step S216). When it is determined to reclassify the group G (Yes at Step S216), the flow proceeds to Step S218. At Step S218, the reclassification unit 25M reclassifies the group G selected at Step S214 (Step S218). Through the processing of Step S218, the unlabeled data 38 belonging to the group G selected at previous Step S214 is reclassified into finer groups G. The flow returns to Step S210.

When it is determined at Step S216 not to reclassify the group G (No at Step S216), on the other hand, the flow proceeds to Step S220. The processing of Step S220 to Step S222 is the same as in the first embodiment (see Step S116 to Step S118 in FIG. 4).

Specifically, at Step S220, the allocation unit 20J allocates a label corresponding to a correct label to unlabeled data 38 belonging to the group G selected at Step S214 (Step S220). Next, the registration unit 20K registers the unlabeled data 38 labeled at Step S220 to the training data 30 as the additional labeled data 34 (Step S222).

Next, the correction unit 25N corrects additional labeled data 34 satisfying the first condition among the additional labeled data 34 in the training data 30 (Step S224). The flow returns to Step S202.

When it is determined to be positive at Step S204 (Yes at Step S204), on the other hand, the flow proceeds to Step S226. At Step S226, the output control unit 25C selects a classifier 22A to be output as a finally defined classifier 22A among classifiers 22A corresponding to version information registered in the storage unit 26 (Step S226).

For example, the output control unit 25C selects a classifier 22A whose recognition rate of validation data 22D is the highest among classifiers 22A corresponding to version information registered in the storage unit 26 as the finally defined classifier 22A.

Specifically, the output control unit 25C uses each of the classifiers 22A registered in the storage unit 26 to recognize a correct label for a pattern registered in the validation data 22D. The output control unit 25C calculates the ratio by which the correct label recognized with use of the classifier 22A matches with a correct label allocated to a pattern registered in the validation data 22D as a recognition rate. The output control unit 25C selects a classifier 22A whose recognition rate is the highest as the finally defined classifier 22A.

The output control unit 25C outputs the classifier 22A selected at Step S226 as the finally defined classifier 22A (Step S228). This routine is finished.

As described above, in the information processing device 10B in the second embodiment, the reclassification determination unit 25L determines whether to reclassify a group G selected by the selection unit 20I. When it is determined to reclassify the group G, the reclassification unit 25M reclassifies the group G.

Thus, the information processing device 10B in the second embodiment can more accurately select and label unlabeled data 38 that may contribute to the improvement in recognition accuracy among pieces of unlabeled data 38. Consequently, the information processing device 10B in the second embodiment can provide data (training data 30) for generating a classifier 22A having higher recognition accuracy in addition to the effects in the first embodiment.

Even when the number of classified groups G is small, the information processing device 10B in the second embodiment can repetitively classify the groups G, and hence can sufficiently classify unlabeled data 38 with high efficiency while suppressing calculation load.

In the information processing device 10B in the second embodiment, the correction unit 25N corrects additional labeled data 34 satisfying the first condition among the additional labeled data 34 registered in the training data 30. Thus, the information processing device 10B can more stably provide data (training data 30) for generating a classifier 22A having high recognition accuracy in addition to the effects in the first embodiment.

### Third Embodiment

In a third embodiment, a mode of using N pieces of training data 30 is described.

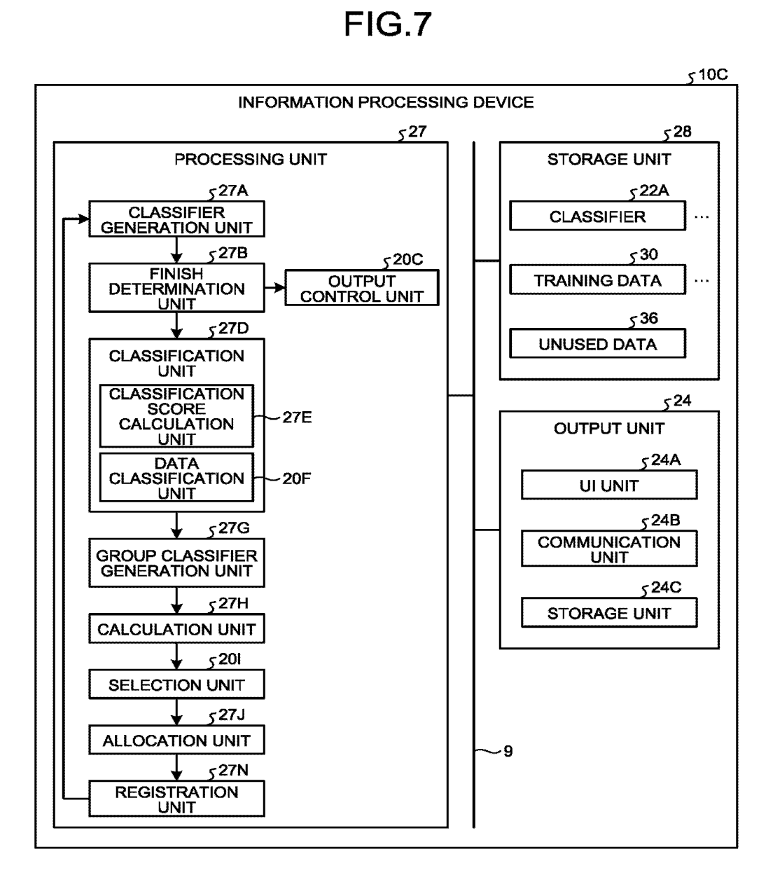

FIG. 7 is a schematic diagram illustrating an example of a configuration of an information processing device 10C in the third embodiment. Configurations having the same functions as those in the above-mentioned embodiments are denoted by the same reference symbols, and descriptions thereof are sometimes omitted.

The information processing device 10C includes a processing unit 27, a storage unit 28, and an output unit 24. The processing unit 27, the storage unit 28, and the output unit 24 are connected via a bus 9. The output unit 24 is the same as in the first embodiment.

The storage unit 28 stores various kinds of data therein. The storage unit 28 stores therein a classifier 22A, training data 30, and unused data 36. In the third embodiment, the storage unit 28 stores N pieces of training data 30 therein. N is an integer of 2 or larger.

N pieces of training data 30 are each a database for registering labeled data 32. Similarly to the first embodiment, the data format of the training data 30 is not limited to a database. In the N pieces of training data 30, the types of correct labels of labeled data 32 are the same. In the N pieces of training data 30, patterns of the labeled data 32 are different at least partially.

Next, the processing unit 27 is described. The processing unit 27 includes a classifier generation unit 27A, a finish determination unit 27B, an output control unit 20C, a classification unit 27D, a group classifier generation unit 27G, a calculation unit 27H, a selection unit 20I, an allocation unit 27J, and a registration unit 27N. The classification unit 27D includes a classification score calculation unit 27E and a data classification unit 20F.

Each of the above-mentioned units is implemented by, for example, one or more processors. For example, each of the above-mentioned units may be implemented by a processor such as a CPU executing a computer program, that is, by software. Each of the above-mentioned units may be implemented by a processor such as a dedicated IC, that is, by hardware. Each of the above-mentioned units is implemented by software and hardware in combination. In the case of using processors, each of the processors may implement one of the units or implement two or more of the units.

The data classification unit 20F, the selection unit 20I, and the output control unit 20C are the same as those in the first embodiment.

The classifier generation unit 27A uses the N pieces of training data 30 to generate N classifiers 22A.

The finish determination unit 27B determines whether to finish learning. The finish determination unit 27B determines whether to finish a series of processing (that is, learning) involving the update of N pieces of training data 30 and the generation of N classifiers 22A.

In the third embodiment, similarly to the finish determination unit 20B in the first embodiment, the finish determination unit 27B determines whether to finish the learning by determining whether the finish condition is satisfied. The finish determination unit 27B may determine to finish the learning when at least one of N pieces of training data 30 satisfies the finish condition.

The classification unit 27D classifies the unlabeled data 38 registered in the unused data 36 into groups G. In the third embodiment, the classification unit 27D classifies pieces of unlabeled data 38 into groups G depending on a correct label registered in each of the N pieces of training data 30.

In the third embodiment, the classification unit 27D includes the classification score calculation unit 27E and the data classification unit 20F.

The classification score calculation unit 27E calculates a classification score for the unlabeled data 38. The classification score is the same as in the first embodiment. Specifically, the classification score is the value related to the degree of similarity to a correct label registered in the training data 30.

In the third embodiment, N pieces of training data 30 are used. Accordingly, the classification score calculation unit 27E calculates, for each piece of unlabeled data 38, the degree of similarity to a correct label registered in each of the N pieces of training data 30. For example, it is assumed that M correct labels are registered in each piece of training data 30. In this case, the classification score calculation unit 27E calculates the N×M degrees of similarity for each piece of unlabeled data 38.

The classification score calculation unit 27E specifies, for each of the unlabeled data 38, a correct label including the largest number of the highest degrees of similarity among the N×M degrees of similarity. The classification score calculation unit 27E calculates, for each piece of the unlabeled data 38, a maximum value or an average value of the N degrees of similarity corresponding to the specified correct label as a classification score of the unlabeled data 38.

Through the processing, the classification score calculation unit 27E calculates one classification score for each respective unlabeled data 38.

Similarly to the first embodiment, the data classification unit 20F classifies the unlabeled data 38 into groups G depending on the classification score.

The group classifier generation unit 27G uses unlabeled data 38 belonging to each of the groups G classified by the classification unit 27D to generate a group classifier 40 for each group G.

In the third embodiment, the group classifier generation unit 27G generates, for each group G, N group classifiers 40 by using N pieces of training data 30. The method of generating the group classifier 40 is the same as in the first embodiment.

The calculation unit 27H uses the group classifier 40 to calculate an evaluation value of a group G corresponding to the group classifier 40. In the third embodiment, as described above, N group classifiers 40 are generated for each group G. Thus, first, the calculation unit 27H calculates, for each group G, an evaluation value of each of the corresponding N group classifiers 40 similarly to the first embodiment. The calculation unit 27H calculates a maximum value or an average value of the N evaluation values calculated for each group G as an evaluation value of the group G. In this manner, the calculation unit 27H calculates one evaluation value for each group G.

The selection unit 20I is the same as in the first embodiment.

The allocation unit 27J specifies, for each piece of the unlabeled data 38 belonging to the selected group G, a correct label having the highest degree of similarity, which is used to derive the classification score calculated by the classification score calculation unit 27E. Specifically, the allocation unit 27J specifies a correct label including the largest number of the highest degrees of similarity among the N×M degrees of similarity calculated by the classification score calculation unit 27E for each piece of the unlabeled data 38. The allocation unit 27J allocates the specified correct label as a label corresponding to a pattern included in the unlabeled data 38.

In this manner, the allocation unit 27J allocates a label corresponding to a correct label to unlabeled data 38 belonging to the group G selected by the selection unit 20I.

The registration unit 27N divides the group G selected by the selection unit 20I into N small groups. Dividing conditions are freely selected, and are not limited. For example, the registration unit 27N divides additional labeled data 34 belonging to the group G selected by the selection unit 20I into N small groups such that the same number of additional labeled data 34 is classified among the small groups. The registration unit 27N may divide additional labeled data 34 such that different numbers of additional labeled data 34 belong to at least part of N small groups.

The registration unit 27N registers additional labeled data 34 belonging to each of the N small groups into each of the N pieces of training data 30. In other words, the registration unit 27N divides the additional labeled data 34 allocated with labels by the allocation unit 27J, which belong to the group G selected by the selection unit 20I, into N pieces, and registers the N pieces of additional labeled data 34 into the N pieces training data 30, respectively.

The classifier generation unit 27A uses the N pieces of training data 30 as described above to generate N classifiers 22A.

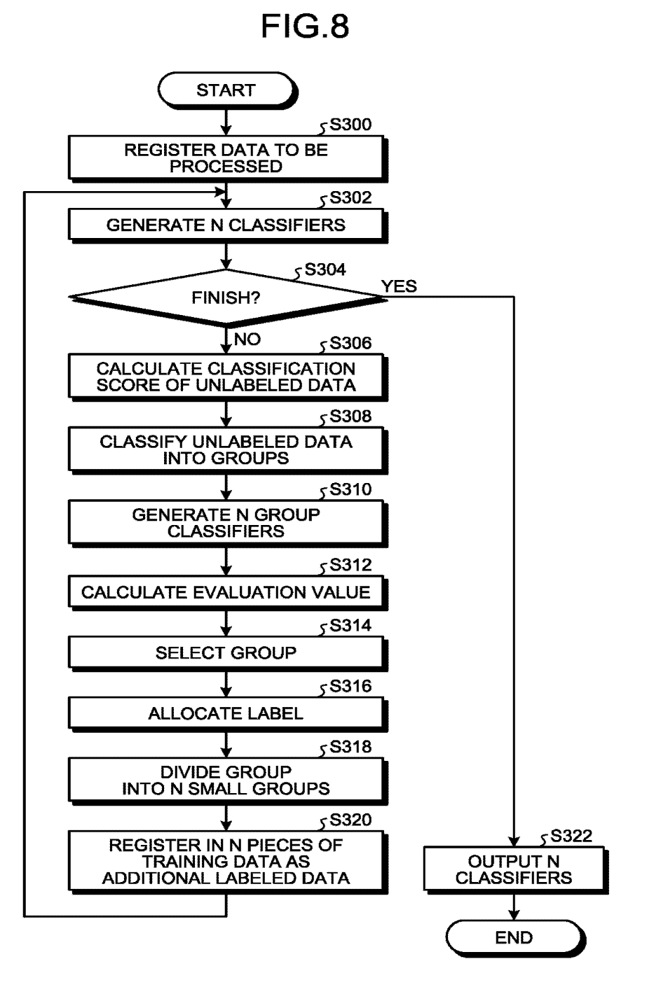

Next, a procedure of information processing executed by the information processing device 10C in the third embodiment is described. FIG. 8 is a flowchart illustrating an example of the procedure of the information processing executed by the information processing device 10C in the third embodiment.

First, the processing unit 27 registers data to be processed in the storage unit 28 (Step S300). In the third embodiment, the processing unit 27 receives data to be processed, which includes N pieces of training data 30 including pieces of labeled data 32 and pieces of unlabeled data 38, from an external device. The processing unit 27 stores the N pieces of training data 30 in the storage unit 28, and registers the pieces of unlabeled data 38 in the unused data 36.

Next, the classifier generation unit 27A uses the N pieces of training data 30 to generate N classifiers 22A (Step S302).

Next, the finish determination unit 27B determines whether to finish learning (Step S304). When it is determined not to finish learning (No at Step S304), the flow proceeds to Step S306. At Step S306, the classification score calculation unit 27E in the classification unit 27D uses the N pieces of training data 30 to calculate a classification score for each of the unlabeled data 38 registered in the unused data 36 (Step S306).

Next, the data classification unit 20F classifies the pieces of unlabeled data 38 registered in the unused data 36 into groups G depending on the classification score (Step S308). Next, the group classifier generation unit 27G generates N group classifiers 40 corresponding to the groups G classified at Step S308 (Step S310).

Next, the calculation unit 27H uses the N classifiers 22A to calculate an evaluation value of a group G corresponding to each of the N group classifiers 40 (Step S312).

Next, the selection unit 20I selects a group G on the basis of the evaluation value calculated at Step S312 (Step S314). Next, the allocation unit 27J allocates a label corresponding to a correct label to unlabeled data 38 belonging to the group G selected at Step S314, thereby obtaining additional labeled data 34 (Step S316).

Next, the registration unit 27N divides the group G selected at Step S314 into N small groups (Step S318). Next, the registration unit 27N registers additional labeled data 34 belonging to the N small groups in the N pieces of training data 30. In other words, the registration unit 27N divides additional labeled data 34 that is allocated with labels by the allocation unit 27J and belong to the group G selected by the selection unit 20I into N pieces, and registers the N pieces of additional labeled data 34 in N pieces of training data 30, respectively (Step S320). The flow proceeds to Step S302.

When it is determined to be positive at Step S304 (Yes at Step S304), on the other hand, the flow proceeds to Step S322. At Step S322, the output control unit 25C outputs N classifiers 22A corresponding to the latest version information as the finally defined classifiers 22A (Step S322). This routine is finished.

As described above, in the third embodiment, the information processing device 10C outputs the N classifiers 22A generated by using the N pieces of training data 30 as the finally decided classifiers 22A.

Consequently, the information processing device 10C in the third embodiment can output a stably high-accurate classifier 22A in addition to the effects in the above-mentioned embodiments.

### Fourth Embodiment

In a fourth embodiment, a method of generating training data 30 by using a plurality of types of unlabeled data 38 having different data formats derived from the same subject is described.

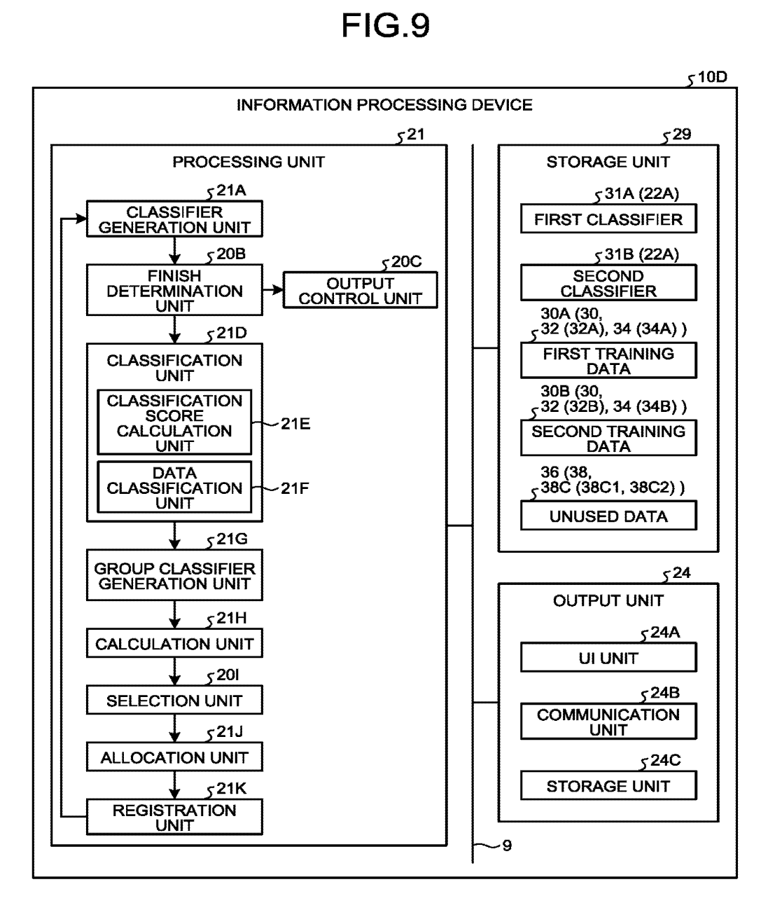

FIG. 9 is a schematic diagram illustrating an example of a configuration of an information processing device 10D in the fourth embodiment. Configurations having the same functions as those in the above-mentioned embodiments are denoted by the same reference symbols, and descriptions thereof are sometimes omitted.

The information processing device 10D includes a processing unit 21, a storage unit 29, and an output unit 24. The processing unit 21, the storage unit 29, and the output unit 24 are connected via a bus 9. The output unit 24 is the same as in the first embodiment.

The storage unit 29 stores various kinds of data therein. In the fourth embodiment, the storage unit 29 stores therein a pair 38C of unlabeled data 38 as unused data 36.

In the fourth embodiment, the case where the information processing device 10D uses two types of unlabeled data 38 as the types of unlabeled data 38 having different data formats is described as an example. However, the information processing device 10D may use three or more types of unlabeled data 38, and the number of types of unlabeled data 38 is not limited to two. The types of unlabeled data 38 may have the same data format as long as a subject is expressed by different methods.

Specifically, the information processing device 10D stores therein a group of pairs 38C of unlabeled data 38 having a first data format and unlabeled data 38 having a second data format obtained from the same subject.

In the following description, the unlabeled data 38 having the first data format is referred to as “first unlabeled data 38C1”, and the unlabeled data 38 having the second data format is referred to as “second unlabeled data 38C2”.

The first unlabeled data 38C1 is unlabeled data 38 in which the data format of an included pattern is the first data format. The second unlabeled data 38C2 is unlabeled data 38 in which the data format of an included pattern is the second data format. As described above in the above-mentioned embodiments, the pattern included in the unlabeled data 38 has not been allocated with a corresponding label yet.

For example, the first unlabeled data 38C1 includes a pattern of sound data, and the second unlabeled data 38C2 includes a pattern of image data. The unlabeled data 38 belonging to the same pair 38C are data obtained from the same subject (for example, an animal of particular kind). Specifically, sound data representing voice of particular kind (for example, a dog) is a pattern included in the first unlabeled data 38C1, and image data representing an image of the dog is a pattern included in the second unlabeled data 38C2.

In the fourth embodiment, the storage unit 29 stores therein, as a classifier 22A, classifiers 22A corresponding to the types of data format treated by the information processing device 10D. In the fourth embodiment, the storage unit 29 stores a first classifier 31A and a second classifier 31B therein.

The first classifier 31A is a classifier 22A for recognizing a correct label for unknown data having the first data format. The second classifier 31B is a classifier 22A for recognizing a correct label for unknown data having the second data format. These classifiers 22A (first classifier 31A and second classifier 31B) are generated by processing by the processing unit 21 described later.

In the fourth embodiment, the storage unit 29 stores therein training data 30 corresponding to the type of data format treated by the information processing device 10D. In the fourth embodiment, the storage unit 29 stores first training data 30A and second training data 30B therein.

The first training data 30A is a database for registering labeled data 32 having the first data format and additional labeled data 34 having the first data format. Specifically, the patterns included in the labeled data 32 and the additional labeled data 34 registered in the first training data 30A are data having the first data format. The data structure of the first training data 30A is not limited to a database.

In the following description, the labeled data 32 having the first data format is referred to as “first labeled data 32A”, and the additional labeled data 34 having the first data format is referred to as “first additional labeled data 34A”.

In the initial state, only the first labeled data 32A is stored in the first training data 30A. Through processing by the processing unit 21 described later, the first additional labeled data 34A is added to the first training data 30A (details are described later).

The second training data 30B is a database for registering labeled data 32 having the second data format and additional labeled data 34 having the second data format. Specifically, patterns included in the labeled data 32 and the additional labeled data 34 registered in the second training data 30B are data having the second data format. The data structure of the second training data 30B is not limited to a database.

In the following description, the labeled data 32 having the second data format is referred to as “second labeled data 32B”, and the additional labeled data 34 having the second data format is referred to as “second additional labeled data 34B”.

In the initial state, only the second labeled data 32B is stored in the second training data 30B. Through processing by the processing unit 21 described later, the second additional labeled data 34B is added to the second training data 30B (details are described later).

The processing unit 21 includes a classifier generation unit 21A, a finish determination unit 20B, an output control unit 20C, a classification unit 21D, a group classifier generation unit 21G, a calculation unit 21H, a selection unit 20I, an allocation unit 21J, and a registration unit 21K. The classification unit 21D includes a classification score calculation unit 21E and a data classification unit 21F.

Each of the above-mentioned units is implemented by, for example, one or more processors. For example, each of the above-mentioned units may be implemented by a processor such as a CPU executing a computer program, that is, by software. Each of the above-mentioned units may be implemented by a processor such as a dedicated IC, that is, by hardware. Each of the above-mentioned units may be implemented by software and hardware in combination. In the case of using processors, each of the processors may implement one of the units or implement two or more of the units.

The classifier generation unit 21A uses the first training data 30A to generate the first classifier 31A. The classifier generation unit 21A uses the second training data 30B to generate the second classifier 31B. The classifier generation unit 21A can generate each of the first classifier 31A and the second classifier 31B similarly to the classifier generation unit 20A in the first embodiment.

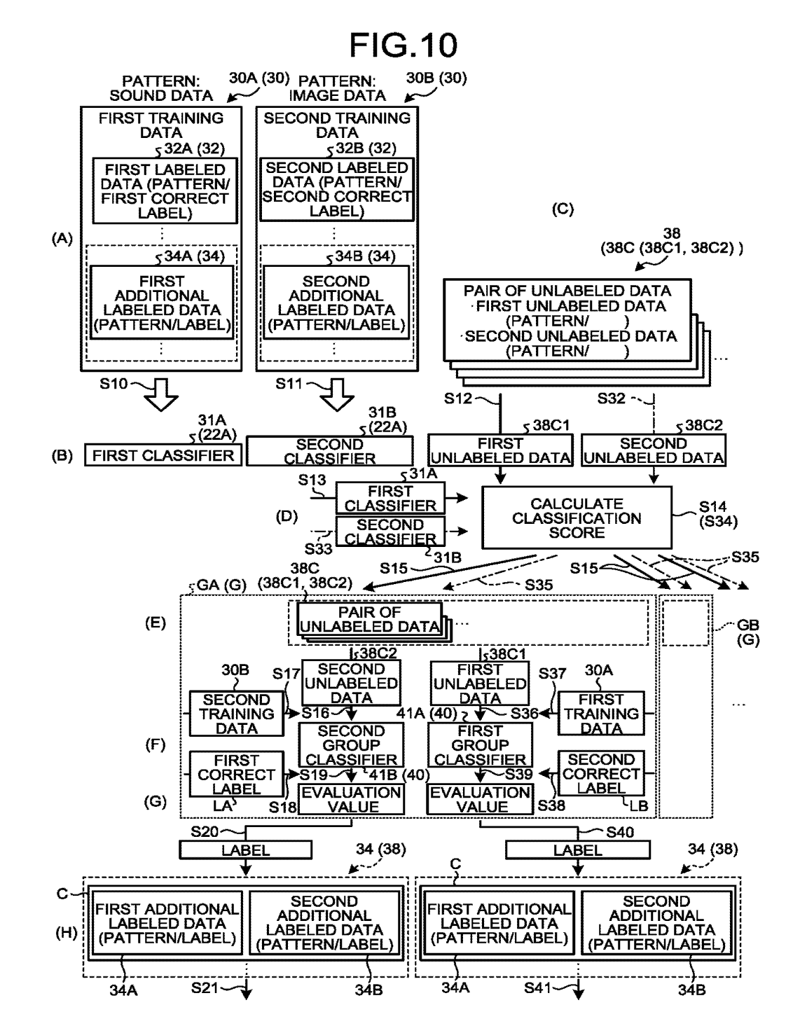

FIG. 10 is a schematic diagram illustrating the flow of information processing executed by the processing unit 21. As illustrated at part (A) and part (B) in FIG. 10, the classifier generation unit 21A uses the first training data 30A to generate the first classifier 31A (Step S10). Similarly, the classifier generation unit 21A uses the second training data 30B to generate the second classifier 31B (Step S11).

In the initial state, only the labeled data 32 (first labeled data 32A, second labeled data 32B) are registered in the first training data 30A and the second training data 30B, respectively. The additional labeled data 34 (first additional labeled data 34A, second additional labeled data 34B) are added to the first training data 30A and the second training data 30B, respectively, by the processing described later. The classifier generation unit 21A uses the latest training data 30 (first training data 30A, second training data 30B) to generate the classifiers 22A (first classifier 31A, second classifier 31B).

The description is continued with reference back to FIG. 9. The finish determination unit 20B and the output control unit 20C are the same as in the first embodiment.

Next, the classification unit 21D, the group classifier generation unit 21G, the calculation unit 21H, the selection unit 20I, the allocation unit 21J, and the registration unit 21K are described. In the fourth embodiment, these units in the processing unit 21 subject unused data 36 to processing corresponding to two types of data formats. Specifically, the following series of processing is performed on a part of groups of pairs 38C of unlabeled data 38 registered in the unused data 36 in accordance with one of the data formats, and then the following series of processing is performed on the remaining part in accordance with the other of the data formats.

The classification unit 21D classifies the groups of pairs 38C of unlabeled data 38 registered in the unused data 36 into groups G.

In the fourth embodiment, similarly to the first embodiment, the classification unit 21D classifies the groups of pairs 38C of unlabeled data 38 into groups G depending on correct labels. In the fourth embodiment, however, when the first data format is to be processed, the classification unit 21D classifies the groups by using a first classifier 31A. When the second data format is to be processed, on the other hand, the classification unit 21D classifies the groups by using a second classifier 31B.

In the fourth embodiment, the classification unit 21D includes the classification score calculation unit 21E and the data classification unit 21F.

The classification score calculation unit 21E calculates a classification score for the unlabeled data 38.

In the fourth embodiment, when the first data format is to be processed, the classification score calculation unit 21E calculates a value related to the degree of similarity to a correct label recognized from the first classifier 31A as the classification score. When the second data format is to be processed, the classification score calculation unit 21E calculates a value related to the degree of similarity to a correct label recognized from the second classifier 31B as the classification score.

The method of calculating the classification score is the same as in the first embodiment except that the classifier 22A (first classifier 31A, second classifier 31B) corresponding to each data format is used.

For example, as illustrated at part (C) and part (D) in FIG. 10, the classification score calculation unit 21E uses the first classifier 31A to calculate a classification score for the first unlabeled data 38C1 (Step S12, Step S13, Step S14). When the second data format is to be processed, the classification score calculation unit 21E uses the second classifier 31B to calculate a classification score for the second unlabeled data 38C2 (Step S32, Step S33, Step S34).

The description is continued with reference back to FIG. 9. The data classification unit 21F classifies the unlabeled data 38 into groups G depending on the classification score similarly to the data classification unit 20F in the first embodiment. For example, the data classification unit 21F classifies the pieces of unlabeled data 38 into groups G such that a group of unlabeled data 38 whose classification scores are similar belong to the same group G.

For example, as illustrated at part (D) and part (E) in FIG. 10, when the first data format is to be processed, the data classification unit 21F classifies the pieces of first unlabeled data 38C1 into groups G (groups GA, GB, . . . in the example illustrated in FIG. 10) depending on the classification score (Step S15).

Similarly, when the second data format is to be processed, the data classification unit 21F classifies the pieces of second unlabeled data 38C2 into groups G (groups GA, GB, . . . in the example illustrated in FIG. 10) depending on the classification score (Step S35). FIG. 10 illustrates an example in which the pieces of second unlabeled data 38C2 are classified into the same groups G irrespective of whether the first data format is to be processed or the second data format is to be processed, but the pieces of second unlabeled data 38C2 are not always classified into the same groups G. This is because classification scores are different between the case where the first data format is to be processed and the case where the second data format is to be processed.

The description is continued with reference back to FIG. 9. The group classifier generation unit 21G uses a pair 38C of unlabeled data 38 belonging to each of groups G classified by the classification unit 21D to generate a group classifier 40 for each group G.

As illustrated at part (E) and part (F) in FIG. 10, in the fourth embodiment, when the first data format is to be processed, the group classifier generation unit 21G uses second unlabeled data 38C2 in the same pair 38C as that for the first unlabeled data 38C1 and second training data 30B to generate a second group classifier 41B (Step S16, Step S17).

The second unlabeled data 38C2 in the same pair 38C as that for the first unlabeled data 38C1 is second unlabeled data 38C2 obtained from the same subject as that for the first unlabeled data 38C1.

In this case, the group classifier generation unit 21G uses a correct label (sometimes referred to as “first correct label LA”) allocated to the first labeled data 32A in the first training data 30A as the label for the second group classifier 41B (Step S18).

Thus, the second group classifier 41B is a group classifier 40 for recognizing a correct label defined by the first classifier 31A (and first labeled data 32A) from unknown data having the second data format.

On the other hand, when the second data format is to be processed, as illustrated at part (E) and part (F) in FIG. 10, the group classifier generation unit 21G uses first unlabeled data 38C1 in the same pair 38C as that for the second unlabeled data 38C2 and first training data 30A to generate a first group classifier 41A (Step S36, Step S37).

In this case, the group classifier generation unit 21G uses a correct label (sometimes referred to as “second correct label LB”) allocated to the second labeled data 32B in the second training data 30B as the label for the first group classifier 41A (Step S38).

Thus, the first group classifier 41A is a group classifier 40 for recognizing a correct label defined by the second classifier 31B (and second labeled data 32B) from unknown data having the first data format.

The description is continued with reference back to FIG. 9. Similarly to the calculation unit 20H in the first embodiment, the calculation unit 21H uses the group classifier 40 to calculate an evaluation value of a group G corresponding to the group classifier 40. Specifically, the calculation unit 21H uses the second group classifier 41B to calculate an evaluation value of a group G corresponding to the second group classifier 41B (see part (G) in FIG. 10 and Step S19).

For calculating the evaluation value of the group G corresponding to the second group classifier 41B, the calculation unit 21H calculates the evaluation value by using a group of patterns of at least part of first labeled data 32A registered in the first training data 30A as a predetermined pattern group.

Similarly, the calculation unit 21H uses the first group classifier 41A to calculate an evaluation value of a group G corresponding to the first group classifier 41A (see part (G) in FIG. 10 and Step S39). For calculating the evaluation value of the group G corresponding to the first group classifier 41A, the calculation unit 21H calculates the evaluation value by using a group of patterns of at least part of second labeled data 32B registered in the second training data 30B as a predetermined pattern group.

Similarly to the first embodiment, the selection unit 20I selects a group G on the basis of the evaluation value. For example, when the first data format is to be processed, the selection unit 20I selects a group G depending on the evaluation value of the generated second group classifier 41B. When the second data format is to be processed, the selection unit 20I selects a group G depending on the evaluation value of the generated first group classifier 41A.

The allocation unit 21J allocates a label corresponding to a correct label to the pair 38C of unlabeled data 38 belonging to the group G selected by the selection unit 20I.

Specifically, when the first data format is to be processed, the allocation unit 21J allocates a label corresponding to a correct label to the first unlabeled data 38C1 and the second unlabeled data 38C2 obtained from the same subject as that for the first unlabeled data 38C1, which belong to the group G selected by the selection unit 20I (see part (G) in FIG. 10, Step S20). The correct label corresponding to the label allocated in this case is a correct label having the highest degree of similarity, which is used to derive the classification score calculated by the classification score calculation unit 21E. Specifically, the correct label corresponding to the label allocated in this case is a correct label recognized from the first classifier 31A.

When the second data format is to be processed, on the other hand, the allocation unit 21J allocates a label corresponding to a correct label to the second unlabeled data 38C2 and the first unlabeled data 38C1 obtained from the same subject as that for the second unlabeled data 38C2, which belong to the group G selected by the selection unit 20I (see part (G) in FIG. 10, Step S40). The correct label corresponding to the label allocated in this case is a correct label having the highest degree of similarity, which is used to derive the classification score calculated by the classification score calculation unit 21E. Specifically, the correct label corresponding to the label allocated in this case is a correct label recognized from the second classifier 31B.

The registration unit 21K registers the labeled unlabeled data 38 to the training data 30 as additional labeled data 34.

In the fourth embodiment, when the first data format is to be processed, the registration unit 21K registers the first unlabeled data 38C1 labeled by the allocation unit 21J to the first training data 30A as first additional labeled data 34A (see part (H) in FIG. 10, Step S21). The registration unit 21K registers second unlabeled data 38C2 labeled by the allocation unit 21J, which is obtained from the same subject as that for the first unlabeled data 38C1, in the second training data 30B as second additional labeled data 34B (see part (H) in FIG. 10, Step S21). In this case, the registration unit 21K deletes the unlabeled data 38 (first unlabeled data 38C1, second unlabeled data 38C2) registered in the training data 30 (first training data 30A, second training data 30B) from the unused data 36.

When the second data format is to be processed, the registration unit 21K registers the second unlabeled data 38C2 labeled by the allocation unit 21J to the second training data 30B as second additional labeled data 34B (see part (H) in FIG. 10, Step S41). The registration unit 21K registers first unlabeled data 38C1 labeled by the allocation unit 21J, which is obtained from the same subject as that for the second unlabeled data 38C2, in the first training data 30A as first additional labeled data 34A (see part (H) in FIG. 10, Step S41). In this case, the registration unit 21K deletes the unlabeled data 38 (first unlabeled data 38C1, second unlabeled data 38C2) registered in the training data 30 (first training data 30A, second training data 30B) from the unused data 36.

In the processing unit 21 in the fourth embodiment, the classification unit 21D, the group classifier generation unit 21G, the calculation unit 21H, the selection unit 20I, the allocation unit 21J, and the registration unit 21K execute the above-mentioned series of processing (classification into groups G, generation of group classifier 40, calculation of evaluation value, selection of group G, allocation of label, and registration to training data 30) for each type of data format to be processed. Thus, the information processing device 10D in the fourth embodiment can use different types of data formats to allocate labels to unlabeled data 38 complementarily and generate training data 30.

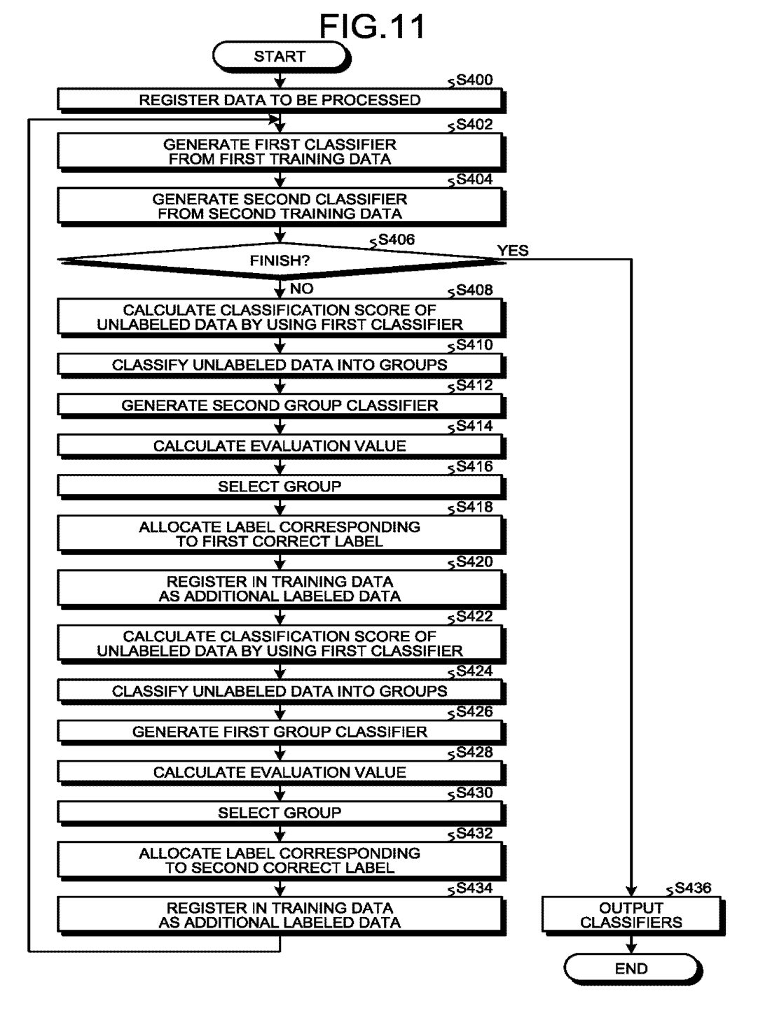

Next, a procedure of information processing executed by the information processing device 10D in the fourth embodiment is described. FIG. 11 is a flowchart illustrating an example of the procedure of the information processing executed by the information processing device 10D in the fourth embodiment.

First, the processing unit 21 registers data to be processed in training data 30 and unused data 36 (Step S400). In the fourth embodiment, it is assumed that the processing unit 21 receives, as the data to be processed, a group of pairs 38C of unlabeled data 38 including first unlabeled data 38C1 and second unlabeled data 38C2 and a group of pairs of first labeled data 32A and second labeled data 32B from an external device. The processing unit 21 registers the first labeled data 32A in the first training data 30A, and registers the second labeled data 32B in the second training data 30B. The processing unit 21 registers a group of the pairs 38C of the unlabeled data 38 including the first unlabeled data 38C1 and the second unlabeled data 38C2 to the unused data 36.

Next, the classifier generation unit 21A uses the first training data 30A to generate a first classifier 31A (Step S402). Next, the classifier generation unit 21A uses the second training data 30B to generate a second classifier 31B (Step S404).

The finish determination unit 20B determines whether to finish the learning (Step S406). When it is determined not to finish the learning (No at Step S406), the flow proceeds to Step S408.

First, it is assumed that the processing unit 21 sets a first data format as a processing subject. In this case, the processing unit 21 executes the processing of Step S408 to Step S420.

Specifically, first, the classification score calculation unit 21E sets part of first unlabeled data 38C1 among pieces of unlabeled data 38 registered in the unused data 36 as processing subjects. The classification score calculation unit 21E calculates, for the pieces of first unlabeled data 38C1 to be processed, values related to the degrees of similarity to a correct label recognized from the first classifier 31A as classification scores (Step S408).

Next, the data classification unit 21F classifies the pieces of first unlabeled data 38C1 to be processed into groups G depending on the classification score calculated at Step S408 (Step S410).

Next, the group classifier generation unit 21G uses second unlabeled data 38C2 in the same pair 38C as that for the first unlabeled data 38C1 to be processed and second training data 30B to generate a second group classifier 41B (Step S412).

Next, the calculation unit 21H uses the second group classifier 41B generated at Step S412 to calculate an evaluation value of a group G corresponding to the second group classifier 41B (Step S414). As described above, the calculation unit 21H calculates the evaluation value by using a group of patterns of at least part of the first labeled data 32A registered in the first training data 30A as a predetermined pattern group.

Next, the selection unit 20I selects a group G depending on the evaluation value calculated at Step S414 (Step S416).

Next, the allocation unit 21J allocates a label corresponding to the first correct label LA to the first unlabeled data 38C1 and the second unlabeled data 38C2 obtained from the same subject as that for the first unlabeled data 38C1 which belong to the group G selected at Step S416 (Step S418).

Next, the registration unit 21K registers the first unlabeled data 38C1 labeled at Step S418 to the first training data 30A as first additional labeled data 34A (Step S420). The registration unit 21K registers second unlabeled data 38C2 labeled by the allocation unit 21J, which is obtained from the same subject as that for the first unlabeled data 38C1, in the second training data 30B as second additional labeled data 34B (Step S420). In this case, the registration unit 21K deletes the unlabeled data 38 (first unlabeled data 38C1, second unlabeled data 38C2) registered in the training data 30 (first training data 30A, second training data 30B) from the unused data 36.

Next, the processing unit 21 sets the second data format as a processing subject. The processing unit 21 executes the processing of Step S422 to Step S434.

Specifically, first, the classification score calculation unit 21E sets pieces of second unlabeled data 38C2 registered in the unused data 36 as processing subjects. The classification score calculation unit 21E calculates, for the pieces of second unlabeled data 38C2 to be processed, values related to the degrees of similarity to a correct label recognized from the second classifier 31B as classification scores (Step S422).

Next, the data classification unit 21F classifies the pieces of second unlabeled data 38C2 to be processed into groups G depending on the classification score calculated at Step S422 (Step S424).

Next, the group classifier generation unit 21G uses first unlabeled data 38C1 in the same pair 38C as the second unlabeled data 38C2 to be processed and the first training data 30A to generate a first group classifier 41A (Step S426).

Next, the calculation unit 21H uses the first group classifier 41A generated at Step S426 to calculate an evaluation value of a group G corresponding to the first group classifier 41A (Step S428). As described above, the calculation unit 21H calculates the evaluation value by using a group of patterns of at least part of second labeled data 32B registered in the second training data 30B as a predetermined pattern group.

Next, the selection unit 20I selects a group G depending on the evaluation value calculated at Step S428 (Step S430).

Next, the allocation unit 21J allocates a label corresponding to the second correct label LB to the second unlabeled data 38C2 and the first unlabeled data 38C1 obtained from the same subject as that for the second unlabeled data 38C2 which belong to the group G selected at Step S430 (Step S432).

Next, the registration unit 21K registers the second unlabeled data 38C2 labeled at Step S432 to the second training data 30B as second additional labeled data 34B (Step S434). The registration unit 21K registers first unlabeled data 38C1 labeled by the allocation unit 21J, which is obtained from the same subject as that for the second unlabeled data 38C2, in the first training data 30A as the first additional labeled data 34A (Step S434). In this case, the registration unit 21K deletes the unlabeled data 38 (first unlabeled data 38C1, second unlabeled data 38C2) registered in the training data 30 (first training data 30A, second training data 30B) from the unused data 36. The flow returns to Step S402.

When it is determined to be positive at Step S406 (Yes at Step S406), on the other hand, the flow proceeds to Step 3436. At Step S436, the output control unit 20C outputs the latest classifier 22A (first classifier 31A, second classifier 31B) generated by the previous processing of Step S402 to Step S434 as the finally defined classifier 22A (Step S436). This routine is finished.

As described above, the information processing device 10D in the fourth embodiment uses different types of data formats to allocate labels to unlabeled data 38 complementarily and generate training data 30 (first training data 30A, second training data 30B).

Consequently, the information processing device 10D in the fourth embodiment can provide data (first training data 30A, second training data 30B) for generating a classifier 22A having higher recognition accuracy in addition to the effects in the first embodiment.

### Fifth Embodiment

In a fifth embodiment, a label to be allocated to unlabeled data 38 is received from the outside.

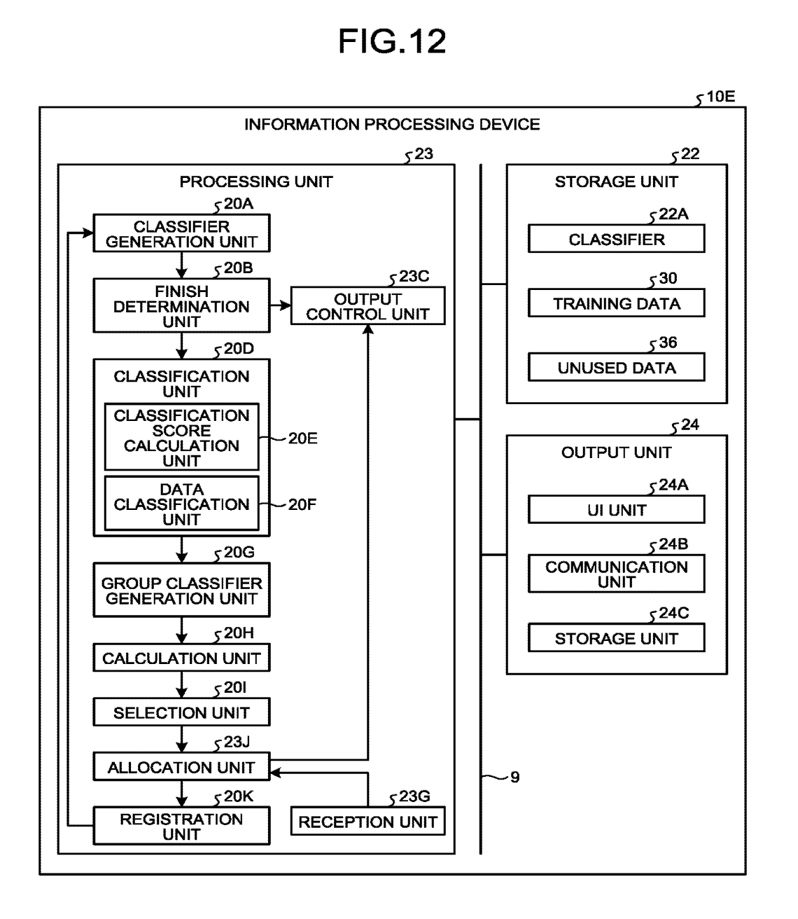

FIG. 12 is a schematic diagram illustrating an example of a configuration of an information processing device 10E in the fifth embodiment. Configurations having the same functions as those in the above-mentioned embodiments are denoted by the same reference symbols, and descriptions thereof are sometimes omitted.

The information processing device 10E includes a processing unit 23, a storage unit 22, and an output unit 24. The processing unit 23, the storage unit 22, and the output unit 24 are connected via a bus 9. The storage unit 22 and the output unit 24 are the same as those in the first embodiment.

The processing unit 23 includes a classifier generation unit 20A, a finish determination unit 20B, an output control unit 23C, a classification unit 20D, a group classifier generation unit 20G, a calculation unit 20H, a selection unit 20I, an allocation unit 23J, a registration unit 20K, and a reception unit 23G.

Each of the above-mentioned units is implemented by, for example, one or more processors. For example, each of the above-mentioned units may be implemented by a processor such as a CPU executing a computer program, that is, by software. Each of the above-mentioned units may be implemented by a processor such as a dedicated IC, that is, by hardware. Each of the above-mentioned units may be implemented by software and hardware in combination. In the case of using processors, each of the processors may implement one of the units or implement two or more of the units.

The classifier generation unit 20A, the finish determination unit 20B, the classification unit 20D, the group classifier generation unit 20G, the calculation unit 20H, the selection unit 20I, and the registration unit 20K are the same as those in the first embodiment.

The allocation unit 23J outputs the unlabeled data 38 belonging to the group G selected by the selection unit 20I to the output control unit 23C.

The output control unit 23C controls the output unit 24 to output various kinds of data. Similarly to the first embodiment, the output control unit 23C outputs the classifier 22A when it is determined by the finish determination unit 20B to finish the learning.

In the fifth embodiment, the output control unit 23C further performs control of outputting (displaying) the unlabeled data 38 received from the allocation unit 23J to (on) the UI unit 24A. Thus, a list of unlabeled data 38 belonging to the group G selected by the selection unit 20I is displayed on the UI unit 24A.

The user operates the UI unit 24A to input a label corresponding to each of patterns included in the unlabeled data 38 displayed on the UI unit 24A. The reception unit 23G receives an input of the label to be allocated to each of the unlabeled data 38 from the UI unit 24A.

Specifically, the reception unit 23G receives an input of the label to be allocated to the unlabeled data 38 belonging to the group G corresponding to the group classifier 40 selected by the selection unit 20I.

The allocation unit 23J allocates the label received by the reception unit 23G to the unlabeled data 38 belonging to the group G selected by the selection unit 20I.

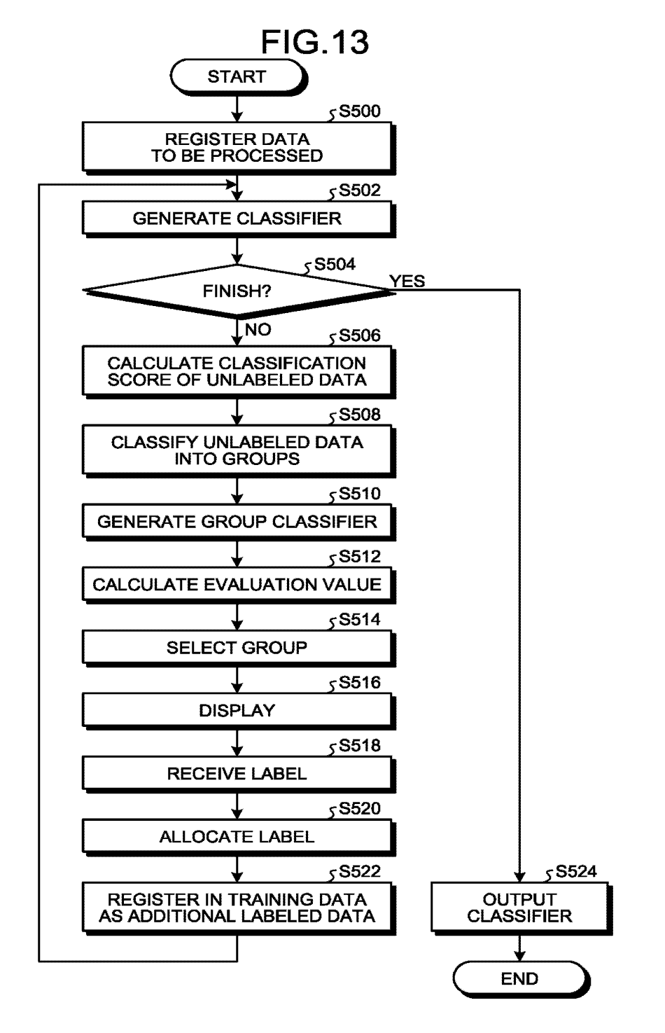

Next, a procedure of information processing executed by the information processing device 10E in the fifth embodiment is described. FIG. 13 is a flowchart illustrating an example of the procedure of the information processing executed by the information processing device 10E in the fifth embodiment.

Similarly to the first embodiment, the information processing device 10E executes processing of Step S500 to Step S514 (see Step S100 to Step S114 in FIG. 4).

Specifically, the processing unit 23 in the information processing device 10E registers data to be processed in training data 30 and unused data 36 (Step S500). Next, the classifier generation unit 20A uses the training data 30 to generate a classifier 22A (Step S502). Next, the finish determination unit 20B determines whether to finish learning (Step S504). When it is determined not to finish learning (No at Step S504), the flow proceeds to Step S506.

At Step S506, the classification score calculation unit 20E in the classification unit 20D calculates a classification score for each of the unlabeled data 38 registered in the unused data 36 (Step S506). Next, the data classification unit 20F classifies the pieces of unlabeled data 38 registered in the unused data 36 into groups G depending on the classification score (Step S508). The group classifier generation unit 20G generates a group classifier 40 (Step S510). Next, the calculation unit 20H uses the group classifier 40 to calculate an evaluation value of a group G corresponding to the group classifier 40 (Step S512). Next, the selection unit 20I selects a group G on the basis of the evaluation value calculated at Step S512 (Step S514).

Next, the allocation unit 23J outputs the unlabeled data 38 belonging to the group G selected at Step S514 to the output control unit 23C. The output control unit 23C displays the received unlabeled data 38 on the UI unit 24A (Step S516).

The user refers to the unlabeled data 38 displayed on the UI unit 24A and inputs a label to a pattern of the unlabeled data 38. The reception unit 23G receives the input of the label corresponding to each of the unlabeled data 38 (Step S518).

The allocation unit 23J allocates the label received at Step S518 to the unlabeled data 38 belonging to the group G selected at Step S514 (Step S520).

Next, the registration unit 20K registers the unlabeled data 38 labeled at Step S520 to the training data 30 as additional labeled data 34 (Step S522). The flow returns to Step S502.

When it is determined to be positive at Step S504 (Yes at Step S504), on the other hand, the flow proceeds to Step S524. At Step S524, the output control unit 23C outputs the classifier 22A (Step S524). This routine is finished.

As described above, in the information processing device 10E in the fifth embodiment, the allocation unit 23J allocates a label received by input from a user to the unlabeled data 38 belonging to the group G selected by the selection unit 20I.

Conventionally, a user allocates labels to all pieces of unlabeled data 38. In the information processing device 10E in the fifth embodiment, on the other hand, labels input by a user are allocated to unlabeled data 38 belonging to a group G selected by the selection unit 20I.

Consequently, the information processing device 10E in the fifth embodiment can reduce operation load on a user in addition to the effects in the above-mentioned first embodiment.

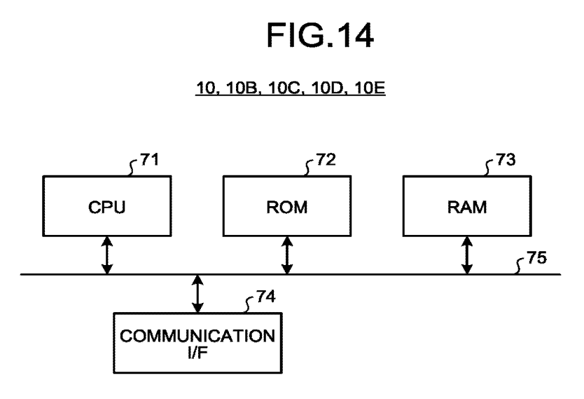

Next, a hardware configuration of the information processing devices 10, 10B, 10C, 10D, and 10E in the above-mentioned embodiments is described. FIG. 14 is an explanatory diagram illustrating the hardware configuration of the information processing devices 10, 10B, 10C, 10D, and 10E in the above-mentioned embodiments.

The information processing devices 10, 10B, 10C, 10D, and 10E in the above-mentioned embodiments include a control device such as a CPU 71, a storage device such as a read only memory (ROM) 72 and a random-access memory (RAM) 73, a communication I/F 74 to be connected to a network for communication, and a bus 75 configured to connect each of the units.

A computer program executed by the information processing devices 10, 10B, 10C, 10D, and 10E in the above-mentioned embodiments is provided by being incorporated in the ROM 72 or the like in advance.

A computer program executed by the information processing devices 10, 10B, 10C, 10D, and 10E in the above-mentioned embodiments may be recorded in a computer-readable recording medium such as a compact disc read only memory (CD-ROM), a flexible disk (FD), a compact disc recordable (CD-R), and a digital versatile disc (DVD) as a file in an installable format or an executable format and provided as a computer program product.

A computer program executed by the information processing devices 10, 10B, 10C, 10D, and 10E in the above-mentioned embodiments may be stored on a computer connected to a network such as the Internet and provided by being downloaded via the network. A computer program executed by the information processing devices 10, 10B, 10C, 10D, and 10E in the above-mentioned embodiments may be provided or distributed via a network such as the Internet.

A computer program executed by the information processing devices 10, 10B, 10C, 10D, and 10E in the above-mentioned embodiments can cause a computer to function as each unit in the information processing devices 10, 10B, 10C, 10D, and 10E in the above-mentioned embodiments. The computer can read the computer program by the CPU 71 from a computer-readable storage medium onto a main storage device and execute the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a classification unit configured to classify unlabeled data into groups;
a calculation unit configured to calculate an evaluation value each of the groups depending on label recognition accuracy of a group classifier for recognizing a label for unknown data, the group classifier being generated for each of the groups by using the unlabeled data belonging to the group;
a selection unit configured to select the group based on the evaluation value; and
an allocation unit configured to allocate a label corresponding to a correct label to the unlabeled data belonging to the selected group.

2. The device according to claim 1, wherein
the classification unit is configured to classify the unlabeled data into the groups depending on the correct label.

3. The device according to claim 1, wherein
the classification unit comprises:
a classification score calculation unit configured to calculate a classification score related to a degree of similarity of the unlabeled data to the correct label; and
a data classification unit configured to classify the unlabeled data into the groups depending on the classification score.

4. The device according to claim 1, wherein
the classification unit comprises:
a reclassification determination unit configured to determine whether to reclassify the group selected by the selection unit; and
a reclassification unit configured to reclassify the group when it is determined to reclassify the group.

5. The device according to claim 1, further comprising a registration unit configured to register, as additional labeled data, the unlabeled data allocated with the label to training data in which labeled data allocated with the correct label is registered.

6. The device according to claim 5, further comprising a classifier generation unit configured to generate a classifier for recognizing a correct label for unknown data by using the training data.

7. The device according to claim 5, further comprising a correction unit configured to correct the additional labeled data satisfying a first condition among the additional labeled data in the training data.

8. The device according to claim 7, wherein
the correction unit is configured to correct the additional labeled data satisfying the first condition in the training data by at least one of changing the allocated label to a label recognized with use of the training data, removing the allocated label and moving the additional labeled data to unused data as the unlabeled data, or deleting the additional labeled data from the training data.

9. The device according to claim 6, wherein
the registration unit is configured to divide the selected group into N small groups, where N is an integer of 2 or larger, and register the additional labeled data belonging to each of the N small groups in N pieces of respective training data, and
the classifier generation unit is configured to generate N respective classifiers by using the N pieces of training data.

10. The device according to claim 6, wherein
the classification unit is configured to classify the unlabeled data having a first data format into the groups by using a first classifier for recognizing a correct label for unknown data having the first data format,
the calculation unit is configured to calculate an evaluation value of each of the groups by using a second group classifier generated in accordance with the unlabeled data having a second data format obtained from a same subject as a subject for the unlabeled data having the first data format belonging to the group and second training data in which the labeled data having the second data format allocated with the correct label is registered,
the selection unit is configured to select the group based on the evaluation value,
the allocation unit is configured to allocate a label corresponding to the correct label to the unlabeled data having the first data format belonging to the selected group and the unlabeled data having the second data format obtained from the same subject as the subject for the unlabeled data having the first data format, and
the registration unit is configured to register the unlabeled data having the first data format allocated with the label into first training data in which the labeled data having the first data format is registered, and register the labeled data having the second data format allocated with the label into the second training data.

11. The device according to claim 1, further comprising a reception unit configured to receive an input of a label to be allocated to the unlabeled data belonging to the group corresponding to the group classifier selected based on the evaluation value, wherein
the allocation unit is configured to allocate the received label to the unlabeled data belonging to the group.

12. An information processing method comprising:
classifying unlabeled data into groups;
calculating an evaluation value of each of the groups depending on label recognition accuracy of a group classifier for recognizing a label for unknown data, is the group classifier being generated for each of the groups by using the unlabeled data belonging to the group,
selecting the group based on the evaluation value; and
allocating a label corresponding to a correct label to the unlabeled data belonging to the selected group.

13. A computer-readable medium that contains an information processing program that causes a computer to execute:
classifying unlabeled data into groups;
calculating an evaluation value of each of the groups depending on label recognition accuracy of a group classifier for recognizing a label for unknown data, the group classifier being generated for each of the groups by using the unlabeled data belonging to the group;
selecting the group based on the evaluation value; and
allocating a label corresponding to a correct label to the unlabeled data belonging to the selected group.
